(19) United States
(12) Patent Application Publication
(10) Pub. No.: US 2002/0152623 A1
(43) Pub. Date: Oct. 24, 2002

(54) Drawing board assembly having angle scale device

(76) Inventors: Chiang-Wen Chen, Taiping City (TW); Chiang-Ming Chen, Taiping City (TW)

Correspondence Address: BACON & THOMAS, PLLC, 625 SLATERS LANE, FOURTH FLOOR, ALEXANDRIA, VA, 22314

(21) Appl. No.: 09/987,303

(22) Filed: Nov. 14, 2001

(30) Foreign Application Priority Data
Apr. 20, 2001 (TW) 86206850A01

(51) Int. Cl. B43L 13/00

(52) U.S. Cl. 33/430

(57) ABSTRACT

A drawing board assembly includes a board having two tracks and two slide bases are movably received in the tracks. A ruler is connected between the two slide bases and a frame is connected to the ruler. The frame has a groove in which a slide member is movably received. A protractor is connected to the slide member and a guide ruler is pivotally connected to the protractor. A bolt extends through the guide ruler and the protractor. A positioning knob is connected to the bolt so that when the bolt is loosened, the guide ruler is pivoted.

### FIELD OF THE INVENTION

The present invention relates to a drawing board and the ruler has a pivotable angle scale device so as to provide angled drawing feature.

### BACKGROUND OF THE INVENTION

A drawing board assembly known to applicant is disclosed in U.S. Pat. No. 5,956,856 with a title of “Drawing Board Assembly” to Chen et al., filed on Dec. 15, 1997. The drawing board assembly provides two racks on two sides of the board and the ruler has two slide bases on two ends thereof. The two slide bases each have a gear which are engaged with the corresponding one of the two racks so as to allow the ruler to be moved in parallel one the board. Although the drawing board assembly improves the shortcomings of a conventional drawing board that guides the ruler by wires enclosed the board, the ruler can only be used to draw horizontal lines and no suitable devices are equipped with the drawing board assembly to obtain an angled lines.

The present invention intends to provide an angle scale device attached to the ruler on a drawing board assembly, the angle scale device is moved with the ruler and pivotable relative to the ruler.

### SUMMARY OF THE INVENTION

In accordance with one aspect of the present invention, there is provided a drawing board assembly and comprises a board having two tracks in two sides thereof and two racks are defined in a top surface on two the sides of the board. Two slide bases are respectively engaged with the two tracks and a ruler is connected between the two slide bases. Each of the two slide bases has a gear which is engaged with one of the two respective racks. A shaft is connected between the two gears and an elongated frame is mounted on the ruler and the shaft is received in the frame. A groove is defined in an underside of the frame and a slide member is movably engaged with the groove. A protractor is connected to the slide member and a passage defined through the protractor. A recess is defined in an underside of the protractor and a first annular flange extends from the underside of the protractor. The first annular flange and the passage share a common axis. The first annular flange encloses the passage. A guide ruler has a circular portion extending from a top thereof and a hole is defined centrally through the circular portion. The circular portion is engaged with the recess and the first annular flange is inserted into the hole of the circular portion.

The primary object of the present invention is to provide a drawing board assembly wherein a protractor and a guide ruler are pivotally connected to the ruler

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a drawing board assembly of the present invention;

FIG. 2 is an exploded view to show a slide base engaged with a track of the drawing board of the present invention;

FIG. 3 is an exploded view to show a slide member, a protractor and a guide ruler of the drawing board of the present invention;

FIG. 4 is a perspective view to show the assembly of the slide member, a protractor and a guide ruler of the drawing board of the present invention;

FIG. 5 is a cross sectional view to show the assembly of the protractor and the guide ruler of the drawing board of the present invention;

FIG. 6 is a cross sectional view to show the slide member, the protractor and the guide ruler of the drawing board of the present invention, and

FIG. 7 is a cross sectional view to show that the guide ruler is pivotable relative to the protractor.

### DETAILED DESCRIPTION OF THE PREFERRED EMBODIMENT

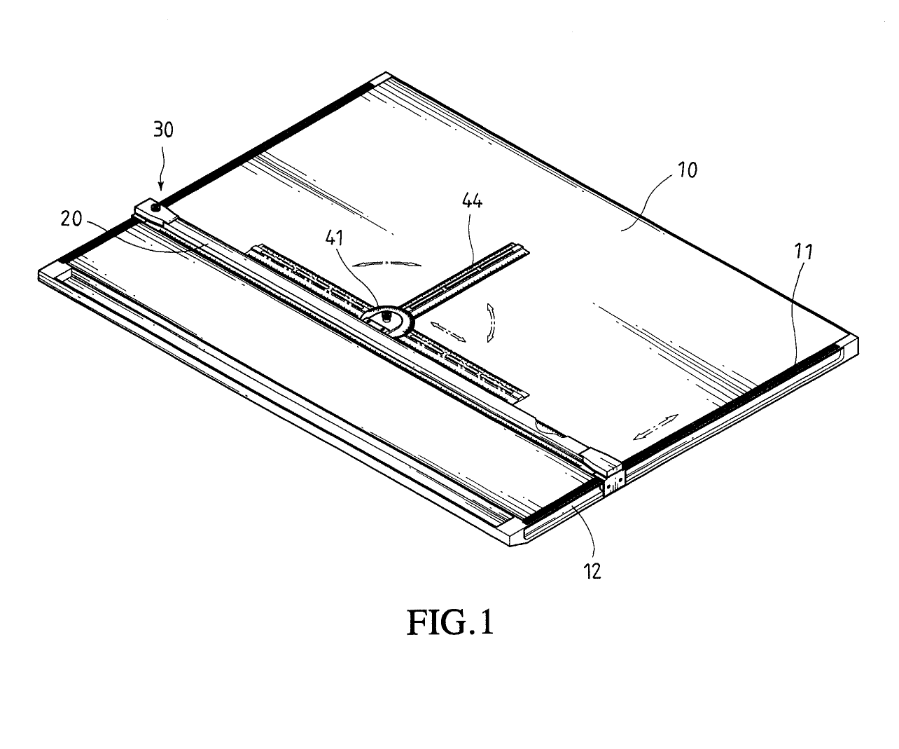

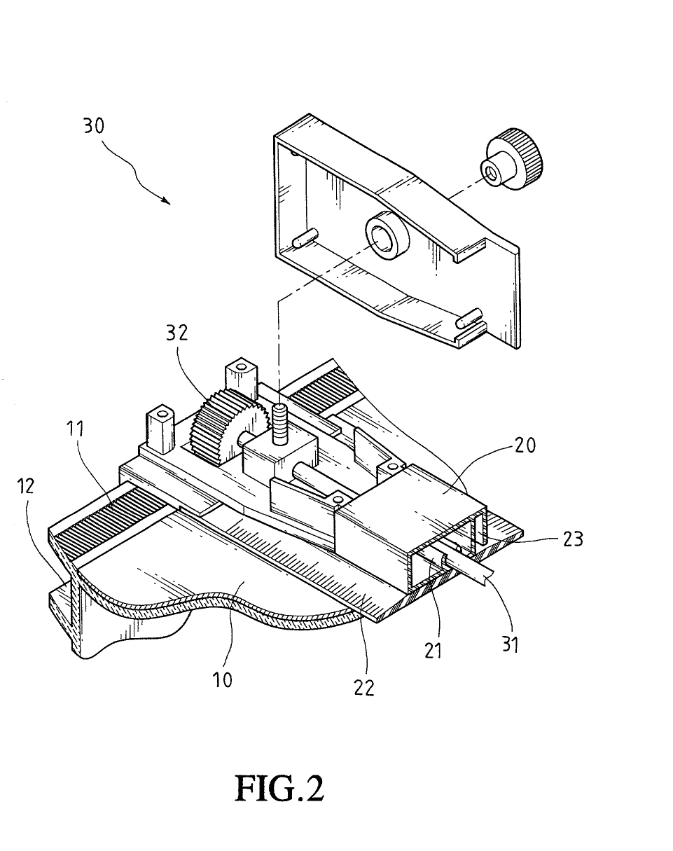

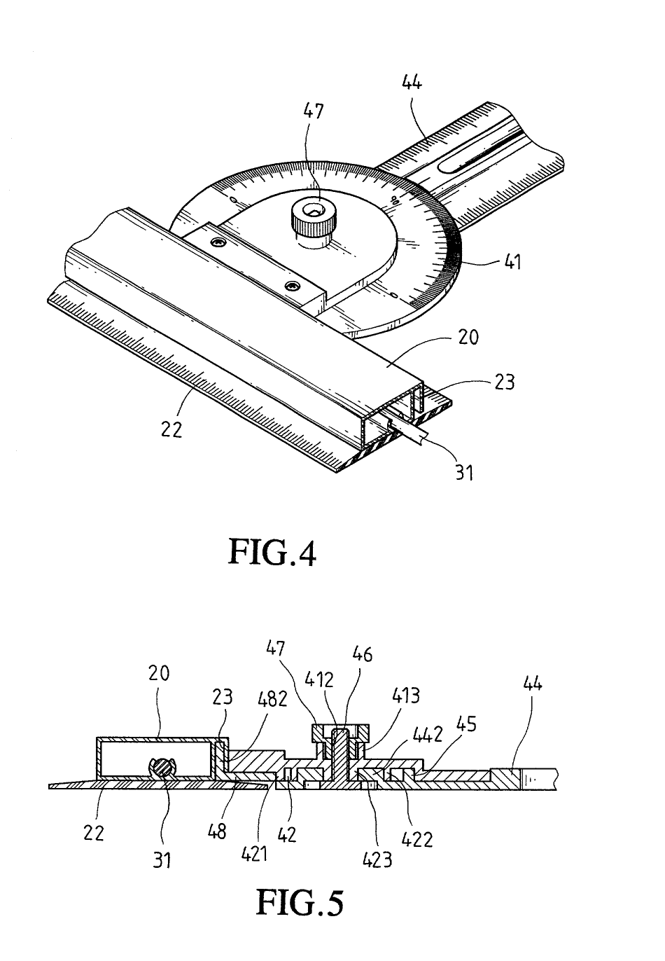

Referring to FIGS. 1 to 4, the drawing board assembly of the present invention comprises a rectangular board 10 having two tracks 12 defined in two sides of the board 10 and two racks 11 are defined in a top surface on two the sides of the board 10. Two slide bases 30 are respectively engaged with the two tracks 12 and a ruler 22 is connected between the two slide bases 30. Each of the two slide bases 30 has a gear 32 which is engaged with one of the two respective racks 11 and a shaft 31 is connected between the two gears 32. An elongated frame 20 is mounted on the ruler 22 and the shaft 31 is received in the frame 20. A groove 23 is defined in an underside of the frame 20 and a slide member 48 is movably engaged with the groove 23 by a vertical plate 482.

A protractor 41 is connected to a horizontal plate of the slide member 48 by extending two tubes 481 on the horizontal plate through two holes 415 in the protractor 41 and two bolts are fixedly connected to the two tubes 481. A tube 413 extends from the top 411 of the protractor 41 and a passage 412 is defined through the tube 413. Scales 414 are marked on the top of the protractor 41. A recess 42 is defined in an underside of the protractor 41 and a first annular flange 423 and a second annular flange 422 respectively extend from the underside of the protractor 41 as shown in FIG. 5. The first annular flange 423, the second annular flange 422 and the passage 412 share a common axis. The first annular flange 423 encloses the passage 412.

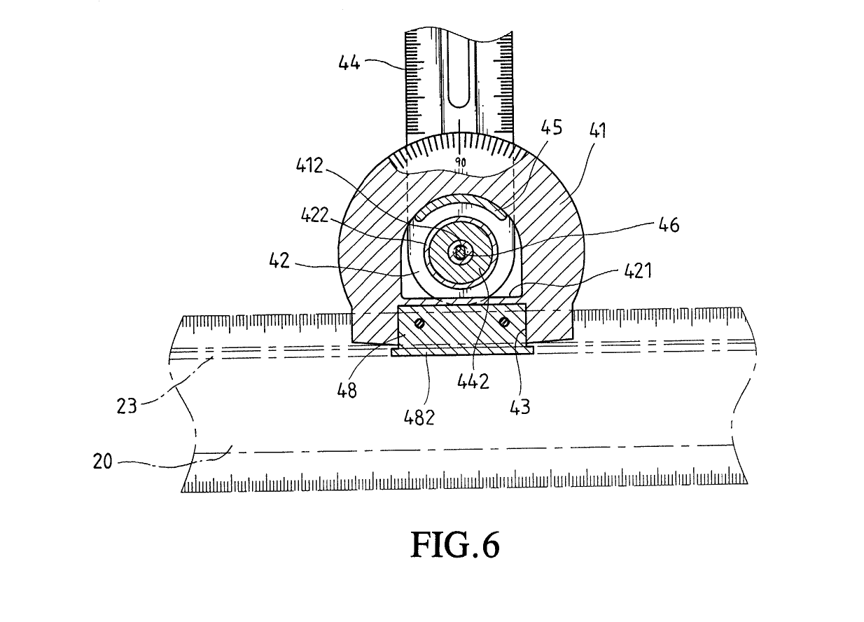

A guide ruler 44 has a circular portion 442 extending from a top thereof and a hole 441 is defined centrally through the circular portion 442. Referring to FIG. 6, the circular portion 442 is engaged with the recess 42 and the first annular flange 423 is inserted into the hole 441 of the circular portion 442. The guide ruler 44 has a curve flange 45 extends from the top of the guide ruler 44. The curve flange 45 and the circular portion 442 share a common axis. The curve flange 45 is engaged with an inner periphery of the recess 42 and the circular portion 442 is engaged with an inner periphery of the second annular flange 422. A bolt 46 extends through the hole 441 in the circular portion 442 and the passage 412. A positioning knob 47 is connected to the bolt 46 on the tube 413.

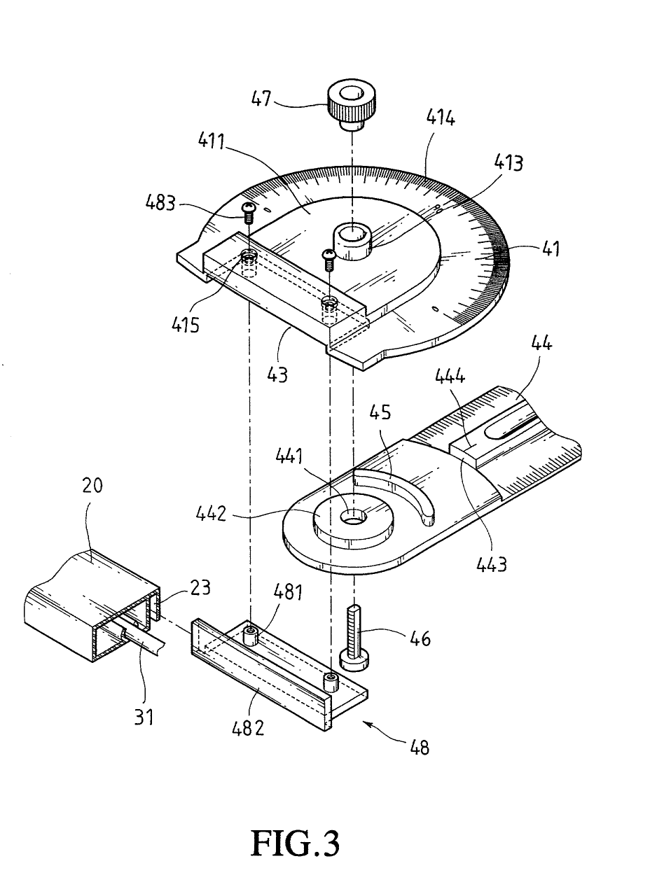

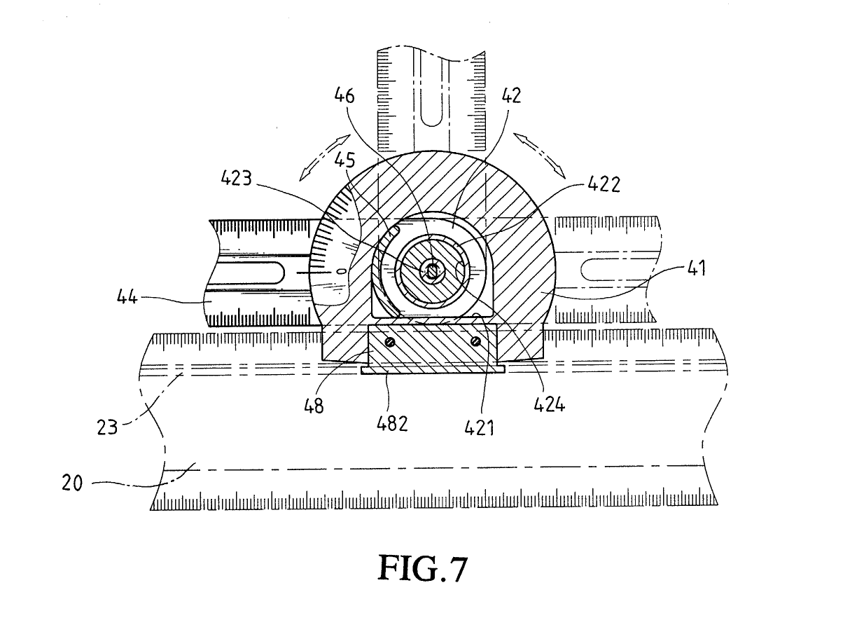

Referring to FIG. 7, a limit flange 421 extends from the underside of the protractor 41 and is located in parallel with the vertical plate 482 of the slide member 48. Two ends of the curve flange 45 respectively contact the limit flange 421 when the guide ruler 41 is pivoted to zero degree position and 180 degree position. The guide ruler 41 has a curve step 443 as shown in FIG. 3 and an outer periphery of the protractor 41 is matched with the curve step 443. A guide mark 444 is marked at the periphery of the curve step 443 so that when the guide mark 444 is in alignment with the scales 414, a precise angle of the guide ruler 44 relative to the ruler 22 is set. The positioning knob 47 is loosened to allow the guide ruler 41 to be pivotable, and when tightening the positioning knob 47, the guide ruler 41 is fixed.

While we have shown and described the embodiment in accordance with the present invention, it should be clear to those skilled in the art that further embodiments may be made without departing from the scope of the present invention.

What is claimed is:

1. A drawing board assembly comprising:
a board having two tracks defined in two sides of said board and two racks defined in a top surface on two said sides of said board, two slide bases respectively engaged with said two tracks and a ruler connected between said two slide bases, each of said two slide bases having a gear which is engaged with one of said two respective racks, a shaft connected between said two gears and an elongated frame mounted on said ruler and said shaft received in said frame, a groove defined in an underside of said frame and a slide member movably engaged with said groove;
a protractor connected to said slide member and a passage defined through said protractor, a recess defined in an underside of said protractor and a first annular flange extending from said underside of said protractor, said first annular flange and said passage sharing a common axis, said first annular flange enclosing said passage, and
a guide ruler having a circular portion extending from a top thereof and a hole defined centrally through said circular portion, said circular portion engaged with said recess and said first annular flange inserted into said hole of said circular portion.

2. The assembly as claimed in claim 1 further comprising a bolt extending through said hole in said circular portion and said passage, a positioning knob connected to said bolt on said protractor.

3. The assembly as claimed in claim 1, wherein said guide ruler has a curve flange extends from said top of said guide ruler, said curve flange and said circular portion sharing a common axis, said curve flange engaged with an inner periphery of said recess.

4. The assembly as claimed in claim 1 further comprising a second annular flange extending from said underside of said protractor, said first annular flange and said second annular flange sharing a common axis, said circular portion is engaged with an inner periphery of said second annular flange.

5. The assembly as claimed in claim 1 wherein said slide member includes a vertical plate which is received in said groove of said frame.

6. The assembly as claimed in claim 1 further comprising a limit flange extending from said underside of said protractor and located in parallel with said vertical plate of said slide member, two ends of said curve flange respectively contacting said limit flange when said guide ruler are pivoted to zero degree position and 180 degree position.
